(19) United States
(12) Patent Application Publication
(10) Pub. No.: US 2016/0104583 A1
(43) Pub. Date: Apr. 14, 2016

(54) PRODUCTION METHOD FOR ALUMINUM POROUS BODY, ALUMINUM POROUS BODY, CURRENT COLLECTOR, ELECTRODE, AND ELECTROCHEMICAL DEVICE

(71) Applicant: SUMITOMO ELECTRIC INDUSTRIES, LTD., Osaka-shi, Osaka (JP)

(72) Inventors: Koutarou KIMURA, Osaka (JP); Kengo GOTO, Osaka (JP); Akihisa HOSOE, Osaka (JP); Junichi NISHIMURA, Osaka (JP); Kazuki OKUNO, Osaka (JP); Hideaki SAKAIDA, Osaka (JP)

(21) Appl. No.: 14/889,871

(22) PCT Filed: May 23, 2014
(86) PCT No.: PCT/JP2014/063652

§ 371 Date: Nov. 9, 2015

(30) Foreign Application Priority Data
May 31, 2013 (JP) 2013-116013

(51) Int. Cl. H01G 11/50; C25D 1/08; H01M 4/80; H01G 11/86; H01M 10/0525; H01M 4/04; H01G 11/68; H01G 11/70; C25D 1/20; H01M 4/66

(52) U.S. Cl. CPC H01G 11/50; C25D 1/20; C25D 1/08; H01M 4/80; H01M 4/661; H01M 10/0525; H01M 4/0469; H01M 4/0471; H01G 11/68; H01G 11/70; H01G 11/86

(57) ABSTRACT

A production method for an aluminum porous body includes a step of producing a resin structure by forming an aluminum film on a surface of a resin base having a three-dimensional network structure by molten salt electrolytic plating, a step of removing moisture from the resin structure, and a step of removing the base by heat-treating the resin structure from which moisture has been removed. In the step of removing moisture from the resin structure, the resin structure is preferably heat-treated at a temperature of 50° C. or higher and 300° C. or lower. In the step of removing the base, the resin structure is preferably heat-treated at a temperature equal to or higher than 370° C. and lower than the melting point of aluminum.

### TECHNICAL FIELD

The present invention relates to a production method for an aluminum porous body having a three-dimensional network structure, an aluminum porous body, a current collector, an electrode, and an electrochemical device.

### BACKGROUND ART

Metal porous bodies having a three-dimensional network structure have been used in wide-ranging fields including various filters, catalyst carriers, and battery electrodes. For example, Celmet (registered trademark, manufactured by Sumitomo Electric Industries, Ltd.) composed of a nickel porous body having a three-dimensional network structure (hereafter referred to as a “nickel porous body”) has been used as an electrode material for batteries such as nickel-hydrogen batteries and nickel-cadmium batteries. Celmet is a metal porous body having continuous pores and has a feature of having a high porosity (90% or more) compared with other porous bodies such as metal nonwoven fabrics.

Such a nickel porous body is produced by forming a nickel layer on a surface of the skeleton of a porous resin having continuous pores, such as a urethane foam, then decomposing the foamed resin molded body through a heat treatment, and further reducing nickel. The nickel layer is formed by coating the surface of the skeleton of the foamed resin molded body with a carbon powder or the like to perform an electrical conduction treatment, and then depositing nickel by electroplating.

As with nickel, aluminum is excellent in terms of conductivity, corrosion resistance, light weight, and the like. In the battery application, for example, an aluminum foil having a surface coated with an active material such as lithium cobaltate is used as a positive electrode of lithium ion batteries.

Japanese Patent No. 3413662 (PTL 1) describes a production method for an aluminum porous body having a three-dimensional network structure in which the surface area of aluminum is increased (hereafter referred to as an “aluminum porous body”). In the method, a three-dimensional network plastic substrate having inner continuous spaces is subjected to an aluminum vapor deposition process by an arc ion plating method to form a 2 to 20 μm aluminum metal layer.

Japanese Unexamined Patent Application Publication No. 08-170126 (PTL 2) describes a method for producing an aluminum porous body in which a film composed of a metal (e.g., copper) that can form a eutectic alloy with aluminum at a temperature equal to or lower than the melting point of aluminum is formed on the skeleton of a foamed resin molded body having a three-dimensional network structure, and then the foamed resin molded body is coated with an aluminum paste and heat-treated at a temperature of 550° C. or higher and 750° C. or lower in a non-oxidizing atmosphere to evaporate the organic component (foamed resin) and to sinter the aluminum powder.

Japanese Unexamined Patent Application Publication No. 2011-225950 (PTL 3) describes another method in which a foamed resin molded body having a three-dimensional network structure is plated with aluminum. According to the method described in PTL 3, a porous resin molded body having a three-dimensional network structure can be uniformly plated with high-purity aluminum, and thus a high-quality aluminum porous body can be produced.

### CITATION LIST

### Patent Literature

PTL 1: Japanese Patent No. 3413662

PTL 2: Japanese Unexamined Patent Application Publication No. 08-170126

PTL 3: Japanese Unexamined Patent Application Publication No. 2011-225950

### SUMMARY OF INVENTION

### Technical Problem

To increase the capacity of the positive electrode that uses aluminum, an aluminum porous body may be employed and the pores of the aluminum porous body may be filled with an active material. This is because, by using the aluminum porous body, such an active material can be retained even when an electrode is thickened and a high availability ratio of the active material per unit area is achieved.

According to the production method for an aluminum porous body described in PTL 1, an aluminum porous body having a thickness of 2 to 20 μm can be produced. However, since this method is a production method that uses a vapor-phase growth process, it is difficult to perform production with a large area, and it is difficult to form a layer that is uniform to the inside if a certain thickness or porosity of the substrate is required. The production method also has the following problems: the rate of formation of the aluminum layer is low; the production cost increases due to, for example, expensive equipment; and, when a thick film is formed, the film may suffer from cracking or falling of aluminum.

In the method for producing an aluminum porous body described in PTL 2, a layer that forms a eutectic alloy with aluminum is formed, and thus a high-purity aluminum layer cannot be formed.

Electrochemical devices that include a nonaqueous electrolyte, such as lithium ion batteries and capacitors, need to be produced in an environment in which moisture is sufficiently removed. Therefore, a current collector used as an electrode also needs to be sufficiently dried. Since a relatively large amount of moisture is adsorbed onto the surface of the skeleton of the aluminum porous body described in PTL 3, a drying process needs to be sufficiently performed in order to use the aluminum porous body as the electrode for electrochemical devices.

Accordingly, it is an object to provide a production method for an aluminum porous body having a three-dimensional network structure with low moisture adsorption.

### Solution to Problem

As a result of intensive studies to achieve the above object, the present inventors have found that, as described in PTL 3, when an aluminum porous body is produced by molten salt electrolytic plating, fine pores having hygroscopicity are formed on a surface of the skeleton and thus the aluminum porous body has a relatively high moisture adsorption. As a result of more detailed studies, it has been found that the fine pores formed on the surface of the skeleton of the aluminum porous body are γ-alumina formed by dehydration of boehmite. The γ-alumina is also used for a moisture absorbent or the like, and the moisture absorbing properties of the γ-alumina have been studied (e.g., “Kawamura Kazuro, Endo Harumi, Characteristics of Adsorption of Moisture on Boehmite and Anhydrous Alumina, Journal of Ceramic Society of Japan 107[4] pp. 335-338 (1998)” and “Li Haizhu, Isshiki Sadahumi, Transformation of γ-alumina, Monthly journal of the Institute of Industrial Science, University of Tokyo, 11(2), pp. 25-29, 1959”).

As a result of further studies, the present inventors have found that, by improving a known method for producing an aluminum porous body having a three-dimensional network structure by a plating method (e.g., Japanese Unexamined Patent Application Publication No. 2011-225950), an aluminum porous body can be produced without forming a γ-alumina layer on a surface of the skeleton.

A production method according to an embodiment of the present invention is (1) a production method for an aluminum porous body, the method including a step of producing a resin structure by forming an aluminum film on a surface of a resin base having a three-dimensional network structure by molten salt electrolytic plating, a step of removing moisture from the resin structure, and a step of removing the base by heat-treating the resin structure from which moisture has been removed.

### Advantageous Effects of Invention

Accordingly, there can be provided a production method for an aluminum porous body having a three-dimensional network structure with low moisture adsorption.

### BRIEF DESCRIPTION OF DRAWINGS

FIG. 1 is an electron micrograph showing a skeleton surface of an aluminum porous body in Example.

FIG. 2 is an electron micrograph showing a skeleton surface of an aluminum porous body in Comparative Example.

FIG. 3 schematically illustrates an example of a structure in which an aluminum porous body is applied to a lithium battery.

FIG. 4 schematically illustrates an example of a structure in which an aluminum porous body is applied to a capacitor.

FIG. 5 schematically illustrates an example of a structure in which an aluminum porous body is applied to a lithium ion capacitor.

FIG. 6 is a schematic sectional view illustrating an example of a structure in which an aluminum porous body is applied to a molten salt battery.

### DESCRIPTION OF EMBODIMENTS

First, the contents of embodiments according to the present invention will be listed and described.

(1) A production method for an aluminum porous body according to an embodiment of the present invention is a production method for an aluminum porous body, the method including a step of producing a resin structure by forming an aluminum film on a surface of a resin base having a three-dimensional network structure by molten salt electrolytic plating, a step of removing moisture from the resin structure, and a step of removing the base by heat-treating the resin structure from which moisture has been removed.

(2) In the production method for an aluminum porous body, in the step of removing moisture from the resin structure, the resin structure is preferably heat-treated at a temperature of 50° C. or higher and 300° C. or lower. In the step of removing the base, the resin structure is preferably heat-treated at a temperature equal to or higher than 370° C. and lower than the melting point of aluminum, thereby removing the base.

(3) In the production method for an aluminum porous body, in the step of removing moisture from the resin structure, the resin structure is preferably heat-treated at a temperature of 370° C. or higher and 500° C. or lower in an atmosphere with a dew point temperature of 0° C. or lower.

In each of the production methods for an aluminum porous body described in (1) to (3), an aluminum porous body in which the surface of a hollow portion of the skeleton is smooth and which has a three-dimensional network structure with low moisture adsorption can be produced.

(4) An aluminum porous body according to an embodiment of the present invention is an aluminum porous body produced by the production method for an aluminum porous body according to any one of (1) to (3).

The aluminum porous body according to an embodiment of the present invention can be used for, for example, an electrode of electrochemical devices. In this case, since the aluminum porous body according to an embodiment of the present invention has a skeleton having a three-dimensional network structure, there can be provided an electrode that can retain a large amount of active material in pores, achieves a high availability ratio of the active material per unit area, and has high capacity.

(5) A current collector according to an embodiment of the present invention is a current collector for an electrochemical device that is composed of the aluminum porous body according to (4).

By using the aluminum porous body according to an embodiment of the present invention as a current collector for an electrochemical device, a high-capacity electrochemical device can be produced. Furthermore, the aluminum porous body according to an embodiment of the present invention has low moisture adsorption. Therefore, when the aluminum porous body is used for an electrochemical device that includes a nonaqueous electrolyte, a burden imposed on an electrode drying process can be reduced.

(6) An electrode according to an embodiment of the present invention is an electrode for an electrochemical device that contains an active material in pores of the aluminum porous body according to (4).

By filling the pores of the aluminum porous body with an active material, a high-capacity electrode can be produced. When the aluminum porous body is used for an electrochemical device that includes a nonaqueous electrolyte, a burden imposed on an electrode drying process can be reduced.

(7) An electrochemical device according to an embodiment of the present invention is an electrochemical device that includes the electrode according to (6).

Since the electrochemical device according to an embodiment of the present invention includes the electrode according to an embodiment of the present invention that achieves a high availability ratio of the active material per unit area, the capacity can be increased. In the case of the electrochemical device that includes a nonaqueous electrolyte, a burden imposed on an electrode drying process can be reduced and thus the production cost can be decreased.

### DETAILS OF EMBODIMENTS OF THE PRESENT INVENTION

Specific examples of a production method for an aluminum porous body according to an embodiment of the present invention will be described below.

The present invention is not limited to these examples and is indicated by the scope of the claims. The present invention is intended to embrace equivalents of the scope of the claims and all modifications within the scope of the claims.

### <Production Method for Aluminum Porous Body>

As described above, the production method for an aluminum porous body according to an embodiment of the present invention includes a step of producing a resin structure by forming an aluminum film on a surface of a resin base having a three-dimensional network structure by molten salt electrolytic plating, a step of removing moisture from the resin structure, and a step of removing the base by heat-treating the resin structure from which moisture has been removed.

Hereafter, each step will be further described in detail.

### (Preparation of Resin Molded Body Having Three-Dimensional Network Structure)

First, a resin molded body having a three-dimensional network structure and continuous pores is prepared. The resin molded body may be made of any resin. The resin molded body is, for example, a foamed resin molded body made of polyurethane, melamine, polypropylene, polyethylene, or the like. The foamed resin molded body is mentioned, but a resin molded body having any form can be selected as long as it has continuous pores. For example, a resin molded body that has a form similar to nonwoven fabric and is prepared by intertwining resin fibers may be used instead of the foamed resin molded body.

A urethane foam and a melamine foam have high porosity, continuity of pores, and an excellent thermal decomposition property. Therefore, they are preferably used as the foamed resin molded body. The urethane foam is preferred in terms of high uniformity of pores, availability, and small pore diameter.

Since a resin molded body often contains residual materials such as a foaming agent and an unreacted monomer that are used in the production of the foam, the resin molded body is preferably subjected to a washing treatment in view of the subsequent steps. The skeleton of the resin molded body forms a three-dimensional network structure, which constitutes continuous pores as a whole. The skeleton of the urethane foam has a triangular shape or a substantially triangular shape in a cross-section perpendicular to the direction in which the skeleton extends.

The foamed resin molded body preferably has a porosity of 80% to 98% and a pore diameter of 50 μm to 500 μm.

The porosity is defined by the following formula.

Porosity=(1−(Weight of porous material[g]/(Volume of porous material[cm³]×Material density)))×100[%]

The pore diameter is determined as follows. The surface of the resin molded body is magnified with, for example, a photomicrograph. The number of pores per inch (25.4 mm) is counted as a cell number and the pore diameter is calculated as an average value: Average pore diameter=25.4 mm/cell number.

### (Electrical Conduction Treatment on Surface of Resin Molded Body)

In order to electroplate a surface of the resin molded body with aluminum, the surface of the resin molded body is subjected to an electrical conduction treatment in advance. The electrical conduction treatment is not particularly limited as long as a conductive layer can be disposed on the surface of the resin molded body. A desired treatment can be selected from, for example, non-electrolytic plating with a conductive metal such as nickel, vapor deposition of aluminum or the like, sputtering of aluminum or the like, and coating with a conductive coating material containing conductive particles such as carbon particles.

Examples of the electrical conduction treatment described below include a method in which the electrical conduction treatment is performed by sputtering of aluminum and a method in which the surface of the resin molded body is subjected to the electrical conduction treatment using carbon as conductive particles.

### —Sputtering of Aluminum—

A sputtering treatment using aluminum is not particularly limited as long as aluminum is used as a target, and can be performed by an ordinary method. For example, a resin molded body is attached to a substrate holder, and a direct-current voltage is then applied between the holder and a target (aluminum) while an inert gas is introduced. The ionized inert gas is caused to collide with aluminum, and sputtered aluminum particles are deposited on the surface of the resin molded body to form a sputtered film composed of aluminum. The sputtering treatment is preferably performed at a temperature at which the resin molded body does not melt. Specifically, the temperature is about 100° C. to 200° C. and preferably about 120° C. to 180° C.

### —Carbon Coating—

First, a carbon coating material serving as a conductive coating material is prepared. A suspension serving as the conductive coating material preferably contains carbon particles, a binder, a dispersant, and a dispersion medium. In order to uniformly apply the conductive particles, the suspension needs to maintain a uniformly suspended state. For this purpose, the suspension is preferably kept at 20° C. to 40° C. This is because when the temperature of the suspension is lower than 20° C., the uniformly suspended state is impaired, and only the binder may be concentrated on a surface of a skeleton forming a network structure of a resin porous body to form a layer of the binder. In this case, the applied carbon particle layer is easily detached, and it is difficult to form a metal plating layer that firmly adheres to the carbon particle layer. On the other hand, when the temperature of the suspension exceeds 40° C., the amount of dispersant evaporated is large. Accordingly, with the lapse of the coating process time, the suspension is concentrated, and the amount of carbon applied tends to vary. The carbon particles preferably have a particle diameter of 0.01 to 5 μm and more preferably 0.01 to 2 μm. When the particle diameter is excessively large, the carbon particles may clog cells of the resin molded body and may inhibit formation of a smooth plating layer. When the particle diameter is excessively small, it is difficult to achieve sufficient electrical conductivity.

The carbon particles can be applied onto the resin molded body by immersing the target resin molded body in the suspension, and conducing squeezing and drying.

### (Formation of Aluminum Film on Surface of Resin Molded Body)

A plating method using a molten-salt bath is employed as a method for forming an aluminum film on a surface of a resin molded body.

### —Molten Salt Plating—

Electrolytic plating is performed in a molten salt to form an aluminum film on a surface of the resin molded body.

By performing aluminum plating in a molten-salt bath, a thick aluminum film can be uniformly formed particularly on the surface of a complex skeleton structure such as a resin molded body having a three-dimensional network structure. A direct current is applied between the resin molded body serving as a cathode and having a surface to which electrical conductivity is imparted and aluminum serving as an anode in a molten salt.

The molten salt may be an organic molten salt that is a eutectic salt of an organic halide and an aluminum halide or an inorganic molten salt that is a eutectic salt of an alkali metal halide and an aluminum halide. When an organic molten-salt bath that causes melting at a relatively low temperature is used, electrolytic plating can be performed without decomposition of a resin molded body serving as a base. An imidazolium salt, a pyridinium salt, or the like can be used as the organic halide. Specifically, 1-ethyl-3-methylimidazolium chloride (EMIC) and butylpyridinium chloride (BPC) are preferred.

Mixing of moisture or oxygen into the molten salt degrades the molten salt. Therefore, the plating is preferably performed in an inert gas atmosphere such as a nitrogen or argon atmosphere in a closed environment.

A bath of a molten salt containing nitrogen is preferred as the molten-salt bath. Among such baths, an imidazolium salt bath is preferably used. In the case where a salt that melts at a high temperature is used as the molten salt, the rate of dissolution or decomposition of a resin in the molten salt is higher than the rate of growth of a plating film, and thus a plating film cannot be formed on the surface of the resin molded body. An imidazolium salt bath can be used even at a relatively low temperature without affecting a resin. A salt containing an imidazolium cation having alkyl groups at the 1- and 3-positions is preferably used as an imidazolium salt. In particular, aluminum chloride-1-ethyl-3-methylimidazolium chloride (AlCl₃-EMIC) molten salts are most preferably used because they have high stability and are not easily decomposed. Plating on a urethane resin foam or a melamine resin foam can be performed, and the temperature of the molten salt bath is 10° C. to 100° C. and preferably 25° C. to 45° C. With a decrease in the temperature of the molten salt bath, the current density range for plating becomes narrow, which makes it difficult to perform plating on the entire surface of a resin molded body. When the temperature is a high temperature of higher than 100° C., the shape of the resin molded body serving as a base tends to be deformed. Through the above steps, an aluminum-resin structure including the resin molded body serving as a core of the skeleton is prepared.

(Removal of Moisture from Resin Structure)

In known production methods for an aluminum porous body, the thus-produced resin porous body is heat-treated to remove a resin. As a result of intensive studies conducted by the present inventors, it has been found that an aluminum porous body can be produced without forming γ-alumina on a surface of the skeleton by modifying this process.

That is, the production method for an aluminum porous body according to an embodiment of the present invention includes a step of removing moisture from the resin structure. When moisture is removed from the resin structure, moisture is also removed from a surface of an aluminum film, which can prevent formation of boehmite caused by reaction of aluminum and water. As described above, in the production method for an aluminum porous body according to an embodiment of the present invention, the formation of boehmite which causes formation of γ-alumina is suppressed, whereby γ-alumina is prevented from being formed on a surface of the skeleton.

Moisture is preferably removed from the resin structure by heat-treating the resin structure at a temperature of 50° C. or higher and 300° C. or lower. When the resin structure is heat-treated at 50° C. or higher, moisture can be efficiently removed from the resin structure. When the resin structure is heat-treated at 300° C. or lower, the reaction of aluminum and water can be suppressed. From this viewpoint, the heat treatment temperature of the resin structure is more preferably 50° C. or higher and 200° C. or lower and further preferably 50° C. or higher and 150° C. or lower.

For the purpose of removing moisture from the resin structure, the heat treatment in which the resin structure is heated to the temperature range of 50° C. or higher and 300° C. or lower is preferably performed in a dry atmosphere with a dew point temperature of 0° C. or lower. Thus, moisture can be more efficiently removed. The dew point temperature in the atmosphere of the heat treatment is more preferably −5° C. or lower and further preferably −10° C. or lower.

The efficiency of removing moisture is substantially saturated at a dew point temperature of about −30° C., and thus the heat treatment may be performed at a dew point temperature of −30° C. or higher.

The atmosphere in which moisture is removed is not particularly limited, and can be suitably selected from, for example, an air atmosphere, a nitrogen atmosphere, an argon atmosphere, and a helium atmosphere.

The time for which moisture is removed from the resin structure may be suitably set in accordance with the temperature and the dew point temperature of the atmosphere. For example, when the resin structure is introduced into a furnace heated to 50° C. in an atmosphere with a dew point temperature of −2° C., moisture can be sufficiently removed by a heat treatment performed for about 30 minutes.

(Removal of Base from Resin Structure)

The resin structure from which moisture has been removed as described above is further heat-treated to remove the base. Thus, an aluminum porous body can be produced. The base can be removed by, for example, heat-treating the resin structure from which moisture has been removed at a temperature equal to or higher than 370° C. and lower than the melting point of aluminum. As a result, the resin is combustibly removed and thus an aluminum porous body having a hollow skeleton is produced. When the heat treatment is performed at 370° C. or higher to remove the resin base, the resin base can be combustibly removed efficiently. When the heat treatment is performed at a temperature lower than the melting point of aluminum to remove the base, the breakdown of the porous structure by melting of aluminum can be suppressed. From these points of view, the heat treatment temperature at which the base is removed is more preferably 500° C. or higher and 660° C. or lower and further preferably 580° C. or higher and 630° C. or lower.

The base may be removed in an air atmosphere or the like, but is preferably removed in a dry atmosphere in order to suppress the reaction between moisture in the atmosphere and aluminum. For example, the resin structure from which moisture has been removed is preferably heated to the above-described temperature range in an air atmosphere with a dew point temperature of 0° C. or lower. The dew point temperature at which the base is removed is more preferably −5° C. or lower and further preferably −10° C. or lower.

The reaction between moisture in the atmosphere and aluminum can be sufficiently suppressed when the dew point temperature at which the base is removed is about −30° C. Therefore, the base may be removed at a dew point temperature of −30° C. or higher.

The atmosphere in which the base is removed is not particularly limited, and can be suitably selected from, for example, an air atmosphere, a nitrogen atmosphere, an argon atmosphere, and a helium atmosphere.

The time for which the base is removed from the resin structure from which moisture has been removed may be suitably set in accordance with the heat treatment temperature. For example, when the resin structure is introduced into a furnace heated to 600° C. in an atmosphere with a dew point temperature of −0.4° C., the base can be sufficiently removed by a heat treatment performed for about 20 minutes.

### —Removal of Moisture and Removal of Base—

In the production method for an aluminum porous body according to an embodiment of the present invention, after the resin structure is produced by forming an aluminum film on a surface of the base, a step of removing moisture from the resin structure and a step of removing the base can be performed by heat-treating the resin structure at a temperature of 370° C. or higher and 500° C. or lower in an atmosphere with a dew point temperature of 0° C. or lower.

In this case, moisture is quickly removed from the resin structure by heat-treating the resin structure in an atmosphere with a dew point temperature of 0° C. or lower. This suppresses the reaction of aluminum and moisture. As a result, an aluminum porous body whose skeleton has a smooth surface can be produced without forming a boehmite layer on a surface of the aluminum film.

In view of quickly removing moisture from the resin porous body and suppressing the reaction between moisture in the atmosphere and aluminum, the dew point temperature at which the heat treatment is performed is more preferably −5° C. or lower and further preferably −10° C. or lower. The efficiency of removing moisture is substantially saturated at a dew point temperature of about −30° C., and thus the heat treatment may be performed at a dew point temperature of −30° C. or higher.

In order to efficiently remove the resin base from the resin structure, the heat treatment is preferably performed by, for example, a method in which the resin structure is introduced into a furnace at 370° C. or higher. The time required to remove the resin can be shortened by further increasing the heat treatment temperature. Therefore, the heat treatment is more preferably performed at 400° C. or higher.

However, if the heat treatment is performed at higher than 500° C., a boehmite layer is easily formed on a surface of the aluminum film of the resin structure. Therefore, the heat treatment temperature is preferably 500° C. or lower and more preferably 480° C. or lower.

### <Aluminum Porous Body>

In the thus-produced aluminum porous body according to an embodiment of the present invention, the surface of the skeleton is smooth because γ-alumina is not formed. Thus, the aluminum porous body is an aluminum porous body with considerably low moisture adsorption.

Specifically, the moisture adsorption of the aluminum porous body according to an embodiment of the present invention is 30 mg/m² or less. In the above-described production method, an aluminum porous body with a moisture adsorption of 20 mg/m² or less and an aluminum porous body with a moisture adsorption of 15 mg/m² or less can be produced by controlling the various conditions in the preferred ranges.

The moisture adsorption of the aluminum porous body refers to an apparent moisture amount per unit area of an aluminum porous body that has been exposed to an atmosphere with a dew point temperature of −20° C. for 24 hours.

The aluminum porous body according to an embodiment of the present invention includes a skeleton having a three-dimensional network structure. Therefore, for example, when the aluminum porous body is used for electrodes of electrochemical devices, the availability ratio of an active material per unit volume can be increased by increasing the amount of the active material retained, which can provide a high-capacity electrode.

Furthermore, the aluminum porous body according to an embodiment of the present invention has low moisture adsorption as described above. Therefore, for example, when the aluminum porous body is used in an environment in which moisture is removed, such as an electrode for batteries and capacitors that include a nonaqueous electrolyte, a burden imposed on a process for removing moisture by drying can be reduced.

The aluminum porous body according to an embodiment of the present invention is produced by plating a surface of a resin porous body having a three-dimensional network structure with aluminum, and the resin base is then removed. The aluminum porous body from which the base has been removed has a hollow skeleton, and therefore the strength of the skeleton is relatively low. Accordingly, for example, when the aluminum porous body is used for electrodes of electrochemical devices, deformation can be relatively easily made after pores are filled with an active material. Thus, the thickness of the electrode can be easily adjusted.

### <Current Collector, Electrode, and Electrochemical Device>

The aluminum porous body according to an embodiment of the present invention can be used for current collectors of electrochemical devices and can also be used for electrodes of electrochemical devices by filling pores with an active material. The electrochemical device is not particularly limited. However, since the aluminum porous body according to an embodiment of the present invention has low moisture adsorption as described above, a burden imposed on a drying process can be reduced by using the aluminum porous body for electrochemical devices that include a nonaqueous electrolyte. For example, a known aluminum porous body produced by a plating method needs to be heat-treated at 150° C. at 5 Torr or less for 16 hours or more to sufficiently dry the aluminum porous body whereas the aluminum porous body according to an embodiment of the present invention can be dried by performing a heat treatment at 150° C. at 5 Torr or less for 2 hours or less.

Hereafter, examples of electrochemical devices that can preferably use the aluminum porous body according to an embodiment of the present invention will be described.

### (Lithium Battery)

A lithium battery will be described as an example of electrochemical devices that include the aluminum porous body according to an embodiment of the present invention. For example, in the case of a positive electrode of a lithium battery (including a lithium ion secondary battery), examples of an active material include lithium cobaltate (LiCoO₂), lithium manganate (LiMn₂O₄), and lithium nickelate (LiNiO₂). The active material is used in combination with a conductive assistant and a binder.

A known positive electrode material for lithium batteries is an electrode formed by coating the surfaces of an aluminum foil with an active material. Lithium batteries have higher capacity than nickel-hydrogen batteries and capacitors. However, a further increase in capacity is required in the uses of automobiles, and the coating thickness of the active material is increased in order to increase the battery capacity per unit area. To effectively use the active material, the active material needs to be in electrical contact with the aluminum foil serving as a current collector, and hence the active material is used as a mixture with a conductive assistant.

In contrast, the aluminum porous body according to an embodiment of the present invention has high porosity and thus has a large surface area per unit area. This increases the contact area between the current collector and the active material. Consequently, the active material can be effectively used, the capacity of the battery can be improved, and the amount of the conductive assistant added can be decreased. In the lithium battery, the above-described positive electrode material is used for a positive electrode, and the negative electrode includes a current collector such as a copper foil, a nickel foil, a punching metal, or a porous body and a negative electrode active material such as graphite, lithium titanate (Li₄Ti₅O₁₂), an alloy containing Sn, Si, or the like, or lithium metal. The negative electrode active material is also used in combination with a conductive assistant and a binder.

Even if such a lithium battery has a small electrode area, the capacity can be increased. Therefore, the energy density of such a lithium battery can be increased compared with known lithium batteries that include an aluminum foil. Although the effect for secondary batteries has been mainly described, the capacity of primary batteries can also be increased because the contact area increases when the aluminum porous body is filled with the active material as in the case of secondary batteries.

### —Structure of Lithium Battery—

Electrolytes used for lithium batteries are nonaqueous electrolytes and solid electrolytes.

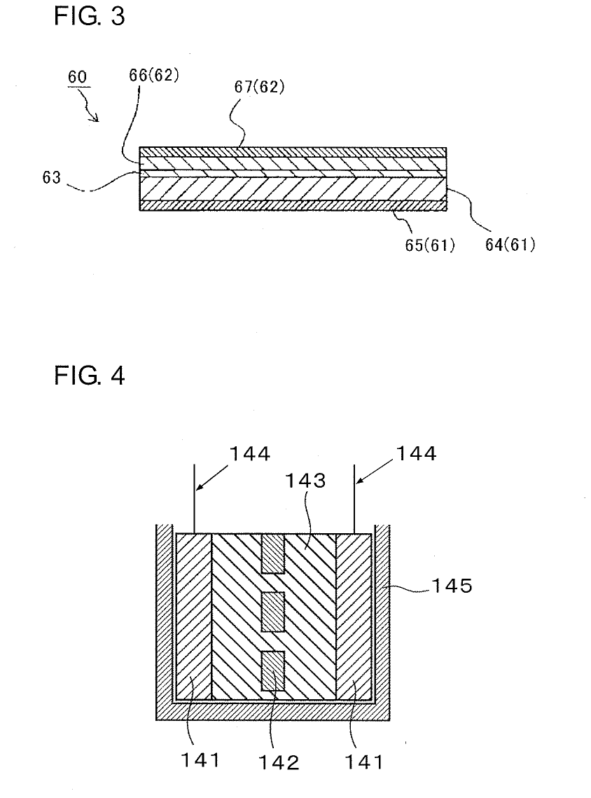

FIG. 3 is a longitudinal sectional view of an all-solid-state lithium battery including a solid electrolyte. An all-solid-state lithium battery 60 includes a positive electrode 61, a negative electrode 62, and a solid electrolyte layer (SE layer) 63 disposed between the electrodes. The positive electrode 61 includes a positive electrode layer (positive electrode body) 64 and a positive electrode current collector 65. The negative electrode 62 includes a negative electrode layer 66 and a negative electrode current collector 67.

An electrolyte other than the solid electrolyte may be a nonaqueous electrolyte described below. In this case, a separator (e.g., a porous polymer film, nonwoven fabric, and paper) is disposed between the electrodes and the nonaqueous electrolyte is impregnated into the electrodes and the separator.

### —Active Material for Filling Aluminum Porous Body—

In the case where an aluminum porous body is used for the positive electrode of a lithium battery, the active material may be a material that allows intercalation and deintercalation of lithium. When the aluminum porous body is filled with such a material, an electrode suitable for lithium secondary batteries can be provided. Examples of a material for the positive electrode active material include lithium cobalt oxide (LiCoO₂), lithium nickel oxide (LiNiO₂), lithium cobalt nickel oxide (LiCo_{0.3}Ni_{0.7}O₂), lithium manganate (LiMn₂O₄), lithium titanate (Li₄Ti₅O₁₂), lithium manganese oxide compounds (LiM_{y}Mn_{2-y}O₄); M=Cr, Co, Ni), and lithium composite oxides. The active material is used in combination with a conductive assistant and a binder. Other examples of a material for the positive electrode active material include transition metal oxides such as known olivine compounds, e.g., lithium iron phosphate (LiFePO₄) and its compound (e.g., LiFe_{0.5}Mn_{0.5}PO₄). The transition metal elements in these materials may be partially substituted with another transition metal element.

Other examples of a material for the positive electrode active material include sulfides such as TiS₂, V₂S₃, FeS, FeS₂, and LiMSₓ (M represents a transition metal element such as Mo, Ti, Cu, Ni, and Fe; or Sb, Sn, and Pb); and metal oxides such as TiO₂, Cr₃O₈, V₂O₅, and MnO₂. The above-described lithium titanate (Li₄Ti₅O₁₂) may also be used as the negative electrode active material.

### —Electrolyte Used for Lithium Battery—

In the nonaqueous electrolyte, a polar aprotic organic solvent is used, such as ethylene carbonate, diethyl carbonate, dimethyl carbonate, propylene carbonate, γ-butyrolactone, or sulfolane. Examples of a supporting salt include lithium tetrafluoroborate, lithium hexafluorophosphate, and imide salts. The concentration of the supporting salt serving as an electrolyte is preferably as high as possible, but is generally about 1 mol/L because of its maximum solubility.

### —Solid Electrolyte for Filling Aluminum Porous Body—

In addition to the active material, a solid electrolyte may be added for the filling. By filling the aluminum porous body with the active material and the solid electrolyte, an electrode suitable for an all-solid-state lithium battery can be provided. The percentage of the active material in the material for filling the aluminum porous body is preferably 50 mass % or more and more preferably 70 mass % or more in view of ensuring discharge capacity.

The solid electrolyte is preferably a sulfide-based solid electrolyte having high lithium ion conductivity. Examples of such a sulfide-based solid electrolyte include sulfide-based solid electrolytes containing lithium, phosphorus, and sulfur. The sulfide-based solid electrolyte may further contain an element such as O, Al, B, Si, and Ge.

The sulfide-based solid electrolyte can be obtained by a publicly known method. For example, lithium sulfide (Li₂S) and phosphorus pentasulfide (P₂S₅) are prepared as starting, materials, Li₂S and P₂S₅ are mixed at a molar ratio of about 50:50 to 80:20, and the resulting mixture is melted and rapidly quenched (melting and rapid quenching) or the resulting mixture is mechanically milled (mechanical milling).

The sulfide-based solid electrolyte obtained by the above-described method is amorphous. Although the sulfide-based solid electrolyte may be used in an amorphous state, it may be heated to form a crystalline sulfide-based solid electrolyte. As a result of crystallization, an increase in the lithium ion conductivity can be expected.

—Filling Aluminum Porous Body with Active Material—

Filling with the active material (or active material and solid electrolyte) may be performed by a publicly known method such as an immersion filling method or a coating method. Examples of the coating method include roll coating, applicator coating, electrostatic coating, powder coating, spray coating, spray coater coating, bar coater coating, roll coater coating, dipping coater coating, doctor blade coating, wire bar coating, knife coater coating, blade coating, and screen printing.

When the active material (or active material and solid electrolyte) is used for filling, for example, the active material is optionally mixed with a conductive assistant and a binder and the resulting mixture is mixed with an organic solvent and water to prepare a positive electrode mixture slurry. An aluminum porous body is filled with the slurry by the above-described method. Examples of the conductive assistant include carbon blacks such as acetylene black (AB) and Ketjen black (KB) and carbon fibers such as carbon nanotube (CNT). Examples of the binder include polyvinylidene fluoride (PVDF), polytetrafluoroethylene (PTFE), polyvinyl alcohol (PVA), carboxymethyl cellulose (CMC), and xanthan gum.

The organic solvent used in the preparation of the positive electrode mixture slurry can be appropriately selected as long as it does not adversely affect materials (that is, an active material, a conductive assistant, a binder, and optionally, a solid electrolyte) used for filling the aluminum porous body. Examples of the organic solvent include n-hexane, cyclohexane, heptane, toluene, xylene, trimethylbenzene, dimethyl carbonate, diethyl carbonate, ethyl methyl carbonate, propylene carbonate, ethylene carbonate, butylene carbonate, vinylene carbonate, vinyl ethylene carbonate, tetrahydrofuran, 1,4-dioxane, 1,3-dioxolane, ethylene glycol, and N-methyl-2-pyrrolidone. When water is used as a solvent, a surfactant may be used to improve the filling properties.

### (Capacitor)

FIG. 4 is a schematic sectional view illustrating an example of a capacitor including electrode materials for capacitors. In an organic electrolyte 143 separated with a separator 142, electrode materials that are aluminum porous bodies carrying electrode active materials are disposed as polarizable electrodes 141. The polarizable electrodes 141 are connected to lead wires 144. The entire structure is contained in a case 145. By using aluminum porous bodies as current collectors, the surface area of the current collectors is increased and the contact area with activated carbon serving as an active material is increased. Consequently, a capacitor having a high power and a high capacitance can be obtained.

To produce an electrode for capacitors, an aluminum porous body current collector is filled with activated carbon serving as an active material. The activated carbon is used in combination with a conductive assistant and a binder.

To increase the capacitance of a capacitor, the content of activated carbon serving as a main component is desirably as high as possible. The content of activated carbon in the composition after drying (after removal of a solvent) is preferably 90% or more. Although the conductive assistant and the binder are necessary, they cause a decrease in the capacitance and the binder causes an increase in the internal resistance. Accordingly, the contents of the conductive assistant and the binder are as low as possible. The content of the conductive assistant is preferably 10 mass % or less. The content of the binder is preferably 10 mass % or less.

The capacitance of the capacitor increases as the surface area of activated carbon increases. Therefore, the specific surface area of the activated carbon is preferably 1000 m²/g or more. Examples of the activated carbon include plant-derived coconut shells and petroleum-based materials. To increase the surface area of the activated carbon, an activation treatment is preferably performed on the activated carbon using water vapor or an alkali.

The electrode materials containing activated carbon as a main component are mixed and stirred to prepare an activated carbon paste. The current collector is filled with the activated carbon paste, dried, and optionally compressed with a roller press or the like to increase the density. Thus, an electrode for capacitors is obtained.

—Filling Aluminum Porous Body with Activated Carbon—

Filling with the activated carbon may be performed by a publicly known method such as an immersion filling method or a coating method. Examples of the coating method include roll coating, applicator coating, electrostatic coating, powder coating, spray coating, spray coater coating, bar coater coating, roll coater coating, dipping coater coating, doctor blade coating, wire bar coating, knife coater coating, blade coating, and screen printing.

When the activated carbon is used for filling, for example, the activated carbon is optionally mixed with a conductive assistant and a binder and the resulting mixture is mixed with an organic solvent and water to prepare a positive electrode mixture slurry. An aluminum porous body is filled with the slurry by the above-described method. Examples of the conductive assistant include carbon blacks such as acetylene black (AB) and Ketjen black (KB) and carbon fibers such as carbon nanotube (CNT). Examples of the binder include polyvinylidene fluoride (PVDF), polytetrafluoroethylene (PTFE), polyvinyl alcohol (PVA), carboxymethyl cellulose (CMC), and xanthan gum.

The organic solvent used in the preparation of the positive electrode mixture slurry can be appropriately selected as long as it does not adversely affect materials (that is, an active material, a conductive assistant, a binder, and optionally, a solid electrolyte) used for filling the aluminum porous body. Examples of the organic solvent include n-hexane, cyclohexane, heptane, toluene, xylene, trimethylbenzene, dimethyl carbonate, diethyl carbonate, ethyl methyl carbonate, propylene carbonate, ethylene carbonate, butylene carbonate, vinylene carbonate, vinyl ethylene carbonate, tetrahydrofuran, 1,4-dioxane, 1,3-dioxolane, ethylene glycol, and N-methyl-2-pyrrolidone. When water is used as a solvent, a surfactant may be used to improve the filling properties.

### —Production of Capacitor—

Two electrode sheets are prepared by blanking out the thus-obtained electrode so as to have an appropriate size. The electrode sheets are placed so as to face each other with a separator therebetween. The separator is preferably a porous membrane formed of cellulose or polyolefin resin, or a nonwoven fabric. The electrodes and the separator are contained in a cell case with necessary spacers so that the electrodes and the separator are impregnated with an electrolyte. Finally, the opening of the case is sealed with a lid through an insulation gasket to produce an electric double layer capacitor.

When a nonaqueous material is used, materials for the electrodes and the like are preferably sufficiently dried to minimize the water content in the capacitor. The capacitor may be produced in an environment having a low water content and the sealing may be performed in an environment having a reduced pressure. The capacitor is not particularly limited as long as the current collector and the electrode according to an embodiment of the present invention are used, and the capacitor may be produced by another method.

Although the electrolyte may be an aqueous electrolyte or a nonaqueous electrolyte, a nonaqueous electrolyte is preferred because a higher voltage can be set. An aqueous electrolyte may be an aqueous potassium hydroxide solution. A nonaqueous electrolyte may be an ionic liquid. There are many ionic liquids constituted by combinations of a cation and an anion. Examples of the cation include lower aliphatic quaternary ammonium, lower aliphatic quaternary phosphonium, and imidazolinium. Known examples of the anion include metal chloride ions, metal fluoride ions, and imide compounds such as bis(fluorosulfonyl)imide. Examples of the nonaqueous electrolyte include polar aprotic organic solvents such as ethylene carbonate, diethyl carbonate, dimethyl carbonate, propylene carbonate, γ-butyrolactone, and sulfolane. Examples of a supporting salt in the nonaqueous electrolyte include lithium tetrafluoroborate and lithium hexafluorophosphate.

### (Lithium Ion Capacitor)

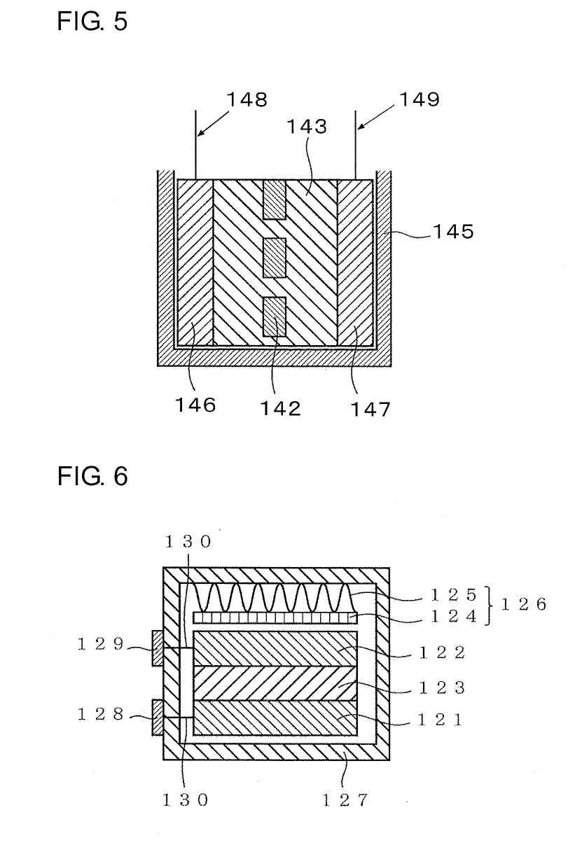

FIG. 5 is a schematic sectional view illustrating an example of a lithium ion capacitor that uses an electrode material for lithium ion capacitors. In an organic electrolyte 143 separated with a separator 142, an electrode material that is an aluminum porous body carrying a positive electrode active material is disposed as a positive electrode 146. An electrode material that is a current collector carrying a negative electrode active material is disposed as a negative electrode 147. The positive electrode 146 and the negative electrode 147 are connected to lead wires 148 and 149, respectively. The entire structure is contained in a case 145. By using an aluminum porous body as a current collector, the surface area of the current collector is increased. Therefore, even when a thin layer of activated carbon serving as an active material is formed, a lithium ion capacitor having a high power and a high capacitance can be obtained.

### —Positive Electrode—

To produce an electrode for lithium ion capacitors, an aluminum porous body current collector is filled with activated carbon serving as an active material. The activated carbon is used in combination with a conductive assistant and a binder.

To increase the capacitance of a lithium ion capacitor, the content of activated carbon serving as a main component is desirably as high as possible. The content of activated carbon in the composition after drying (after removal of a solvent) is preferably 90% or more. Although the conductive assistant and the binder are necessary, they cause a decrease in the capacitance and the binder causes an increase in the internal resistance. Accordingly, the contents of the conductive assistant and the binder are as low as possible. The content of the conductive assistant is preferably 10 mass % or less. The content of the binder is preferably 10 mass % or less.

The capacitance of the lithium ion capacitor increases as the surface area of activated carbon increases. Therefore, the specific surface area of the activated carbon is preferably 1000 m²/g or more. Examples of the activated carbon include plant-derived coconut shells and petroleum-based materials. To increase the surface area of the activated carbon, an activation treatment is preferably performed on the activated carbon using water vapor or an alkali. Examples of the conductive assistant include Ketjen black, acetylene black, carbon fibers, and composite materials of the foregoing. Examples of the binder include polyvinylidene fluoride, polytetrafluoroethylene, polyvinyl alcohol, carboxymethyl cellulose, and xanthan gum. The solvent may be appropriately selected from water and an organic solvent depending on the type of binder. When the solvent is an organic solvent, N-methyl-2-pyrrolidone is often used. When the solvent is water, a surfactant may be used to improve the filling properties.

The electrode materials containing activated carbon as a main component are mixed and stirred to prepare an activated carbon paste. The current collector is filled with the activated carbon paste, dried, and optionally compressed with a roller press or the like to increase the density. Thus, an electrode for lithium ion capacitors is obtained.

—Filling Aluminum Porous Body with Activated Carbon—

Filling with the activated carbon may be performed by a publicly known method such as an immersion filling method or a coating method. Examples of the coating method include roll coating, applicator coating, electrostatic coating, powder coating, spray coating, spray coater coating, bar coater coating, roll coater coating, dipping coater coating, doctor blade coating, wire bar coating, knife coater coating, blade coating, and screen printing.

When the activated carbon is used for filling, for example, the activated carbon is optionally mixed with a conductive assistant and a binder and the resulting mixture is mixed with an organic solvent and water to prepare a positive electrode mixture slurry. An aluminum porous body is filled with the slurry by the above-described method. Examples of the conductive assistant include carbon blacks such as acetylene black (AB) and Ketjen black (KB) and carbon fibers such as carbon nanotube (CNT). Examples of the binder include polyvinylidene fluoride (PVDF), polytetrafluoroethylene (PTFE), polyvinyl alcohol (PVA), carboxymethyl cellulose (CMC), and xanthan gum.

The organic solvent used in the preparation of the positive electrode mixture slurry can be appropriately selected as long as it does not adversely affect materials (that is, an active material, a conductive assistant, a binder, and optionally, a solid electrolyte) used for filling the aluminum porous body. Examples of the organic solvent include n-hexane, cyclohexane, heptane, toluene, xylene, trimethylbenzene, dimethyl carbonate, diethyl carbonate, ethyl methyl carbonate, propylene carbonate, ethylene carbonate, butylene carbonate, vinylene carbonate, vinyl ethylene carbonate, tetrahydrofuran, 1,4-dioxane, 1,3-dioxolane, ethylene glycol, and N-methyl-2-pyrrolidone. When water is used as a solvent, a surfactant may be used to improve the filling properties.

### —Negative Electrode—

The negative electrode is not particularly limited and may be a known negative electrode for lithium batteries. However, since a known electrode employing an copper foil as a current collector has a low capacitance, an electrode prepared by filling a copper or nickel porous body such as the above-described nickel foam with an active material is preferably used. To achieve an operation as a lithium ion capacitor, the negative electrode is preferably doped with a lithium ion in advance. The doping can be performed by a publicly known method. Examples of the method include a method in which a lithium metal foil is attached to the surface of a negative electrode and immersed into an electrolyte to perform doping; a method in which an electrode to which a lithium metal is attached is disposed in a lithium ion capacitor, a cell is assembled, and then an electric current is caused to flow between the negative electrode and the lithium metal electrode to electrically achieve doping; and a method in which an electrochemical cell is assembled using a negative electrode and a lithium metal and a negative electrode electrically doped with lithium is detached and used.

In any method, the doping amount of lithium is desirably large to sufficiently decrease the negative electrode potential. However, if the residual capacity of the negative electrode is lower than the positive electrode capacity, the capacitance of a lithium ion capacitor decreases. Therefore, a capacity corresponding to the capacity of the positive electrode is preferably left without performing doping.

### —Electrolyte Used for Lithium Ion Capacitor—

The electrolyte used is the same nonaqueous electrolyte as that used for lithium batteries. In the nonaqueous electrolyte, a polar aprotic organic solvent is used, such as ethylene carbonate, diethyl carbonate, dimethyl carbonate, propylene carbonate, γ-butyrolactone, and sulfolane. Examples of a supporting salt include lithium tetrafluoroborate, lithium hexafluorophosphate, and imide salts.

### —Production of Lithium Ion Capacitor—

An electrode sheet is prepared by blanking out the thus-obtained electrode so as to have an appropriate size, and the electrode sheet is made to face a negative electrode with a separator disposed therebetween. The negative electrode may be a negative electrode doped with a lithium ion by the above-described method. When a method in which doping is performed after assembling of a cell is employed, an electrode to which a lithium metal is connected may be disposed in a cell. The separator is preferably a porous membrane formed of cellulose or polyolefin resin, or a nonwoven fabric. The electrodes and the separator are contained in a cell case with necessary spacers so that the electrodes and the separator are impregnated with an electrolyte. Finally, the opening of the case is sealed with a lid through an insulation gasket to produce a lithium ion capacitor.

Materials for the electrodes and the like are preferably sufficiently dried to minimize the water content in the lithium ion capacitor. The lithium ion capacitor may be produced in an environment having a low water content and the sealing may be performed in an environment having a reduced pressure. The lithium ion capacitor is not particularly limited as long as the current collector and the electrode according to an embodiment of the present invention are used, and the lithium ion capacitor may be produced by another method.

### (Electrode for Molten Salt Battery)

The aluminum porous body can also be used as an electrode material for molten salt batteries. When the aluminum porous body is used as a positive electrode material, a metal compound capable of intercalating cations of a molten salt serving as an electrolyte, that is, sodium chromite (NaCrO₂), titanium disulfide (TiS₂), or the like is used as the active material. The active material is used in combination with a conductive assistant and a binder. An example of the conductive assistant is acetylene black. An example of the binder is polytetrafluoroethylene (PTFE). When sodium chromite is used as the active material and acetylene black is used as the conductive assistant, PTFE is preferably used to more firmly adhere the active material and the conductive assistant to each other.

The aluminum porous body can also be used as a negative electrode material for molten salt batteries. When the aluminum porous body is used as a negative electrode material, examples of the active material include elemental sodium, alloys of sodium and another metal, and carbon. Since sodium has a melting point of about 98° C. and metal softens with a temperature increase, an alloy of sodium and another metal (e.g., Si, Sn, and In) is preferably used. In particular, an alloy of sodium and Sn is preferred because of its ease of handling. Sodium or a sodium alloy can be carried on the surface of the aluminum porous body by electrolytic plating, hot dipping, or the like. Alternatively, after sodium and a metal (e.g., Si) that is to form an alloy with sodium are made to adhere to the aluminum porous body by plating or the like, a sodium alloy can be formed by performing charging in a molten salt battery.

FIG. 6 is a schematic sectional view illustrating an example of a molten salt battery including the above-described electrode material for batteries. The molten salt battery includes, in a case 127, a positive electrode 121 in which a positive electrode active material is carried on the surface of an aluminum skeleton of an aluminum porous body, a negative electrode 122 in which a negative electrode active material is carried on the surface of an aluminum skeleton of an aluminum porous body, and a separator 123 impregnated with a molten salt serving as an electrolyte. A pressing member 126 constituted by a presser plate 124 and a spring 125 pressing the presser plate is disposed between the upper surface of the case 127 and the negative electrode. Even when the volumes of the positive electrode 121, the negative electrode 122, and the separator 123 vary, the pressing member uniformly presses these components so that these components are in contact with one another. The current collector (aluminum porous body) of the positive electrode 121 and the current collector (aluminum porous body) of the negative electrode 122 are respectively connected to a positive electrode terminal 128 and a negative electrode terminal 129 through lead wires 130.

The molten salt serving as the electrolyte may be an inorganic salt or an organic salt that melts at the operation temperature. The cation of the molten salt may be one or more selected from alkali metals such as lithium (Li), sodium (Na), potassium (K), rubidium (Rb) and cesium (Cs), and alkaline earth metals such as beryllium (Be), magnesium (Mg), calcium (Ca), strontium (Sr) and barium (Ba).

To decrease the melting point of the molten salt, two or more salts are preferably used in combination. For example, when potassium bis(fluorosulfonyl)amide <K—N(SO₂F)₂; KFSA> and sodium bis(fluorosulfonyl)amide <Na—N(SO₂F)₂; NaFSA> are used in combination, the operation temperature of the battery can be controlled to 90° C. or less.

The molten salt is used such that a separator is impregnated therewith. The separator is configured to prevent the positive electrode and the negative electrode from coming into contact with each other. The separator may be formed of, for example, a glass nonwoven fabric or a porous resin porous body. The positive electrode, the negative electrode, and the separator impregnated with the molten salt are stacked and contained in a case, and used as a battery.

### EXAMPLES

Hereafter, the present invention will be further described in detail based on Examples, but these Examples are merely examples and the production method for an aluminum porous body according to the present invention and the like are not limited thereto. The scope of the present invention is indicated by the scope of the claims, and embraces equivalents of the scope of the claims and all modifications within the scope of the claims.

### Example 1

A urethane foam having a porosity of 96%, a cell number of 46/inch, a pore diameter of about 550 μm, and a thickness of 1.0 mm was prepared as a resin molded body. The urethane foam was cut into a size of 100 mm×100 mm. An aluminum film having a coating weight of 10 g/m² was formed by sputtering on the surface of the polyurethane foam to form a conductive layer.

The urethane foam on which the conductive layer was formed was set as a work in a jig having a power feeding function, placed in a glove box having an argon atmosphere and a low water content (dew point: −30° C. or lower), and immersed in a molten salt aluminum plating bath (33 mol % EMIC-67 mol % AlCl₃) at 40° C. The jig in which the work was set was connected to the cathode side of a rectifier and an aluminum plate (purity: 99.99 mass %) serving as a counter electrode was connected to the anode side of the rectifier.

A direct current having a current density of 6.5 A/dm² was applied for 20 minutes to perform plating. Thus, a resin structure in which an aluminum film with a mass of 140 g/m² was formed on the surface of the urethane foam was obtained. Stirring was performed in a stirrer using a rotor made of Teflon (registered trademark). The current density was calculated using the apparent area of the urethane foam.

The obtained resin structure was taken out of the plating bath. In a state in which the coating weight of the plating solution was 18 mL/m², the resin structure was washed with water having a temperature of 10° C. Subsequently, moisture was removed from the resin structure using a blower.

The resin structure was introduced into a furnace having an air atmosphere with a dew point temperature of −15° C. and heat-treated at 150° C. for 60 minutes. Consequently, the resin structure was dried and moisture was sufficiently removed.

Subsequently, the resin structure from which moisture was removed was heat-treated at 600° C. for 20 minutes in a furnace having an air atmosphere with a dew point temperature of −15° C. Consequently, a resin base was removed from the resin structure, and an aluminum porous body A having a three-dimensional network structure with a hollow skeleton was obtained.

### Example 2

As in the case of Example 1, an aluminum film was formed on the surface of a urethane foam to produce a resin structure, a plating solution that adhered to the resin structure was removed by being washed with water, and moisture was removed using a blower.

Subsequently, the resin structure was introduced into a furnace having an air atmosphere with a dew point temperature of −15° C. and heat-treated at 500° C. for 20 minutes. Consequently, an aluminum porous body B in which moisture was removed from the resin structure and a resin base was removed was obtained.

### Comparative Example 1

As in the case of Example 1, an aluminum film was formed on the surface of a urethane foam to produce a resin structure, and a plating solution that adhered to the resin structure was removed by being washed with water.

Subsequently, the resin structure was introduced into a furnace having an air atmosphere with a dew point temperature of 20° C. and heat-treated at 600° C. for 20 minutes. Consequently, an aluminum porous body C was obtained.

### Comparative Example 2

As in the case of Example 1, an aluminum film was formed on the surface of a urethane foam to produce a resin structure, and a plating solution that adhered to the resin structure was removed by being washed with water.

Subsequently, the resin structure was introduced into a furnace having an air atmosphere with a dew point temperature of 2° C. and heat-treated at 600° C. for 20 minutes. Consequently, an aluminum porous body D was obtained.

### —Evaluation—

### <Moisture Adsorption>

The moisture adsorption of the aluminum porous bodies A to D obtained as described above was measured by a Karl Fischer coulometric titration method.

First, the aluminum porous bodies A to D were respectively cut into five test specimens A to D for measurement each having a size of 10 mm×50 mm. The test specimens A to D were sufficiently dried by performing a heat treatment in an inert atmosphere such as a nitrogen or argon atmosphere at 300° C. for 10 minutes. The test specimens were then exposed to an atmosphere with a dew point of −20° C. for 24 hours.

The moisture adsorption of the test specimens A to D subjected to the pretreatment was measured by a Karl Fischer coulometric titration method using a moisture vaporizer heated to 300° C. The titration was ended when the detected water content reached “background value+0.1 μg/sec”.

As a result of the measurement of the moisture adsorption of the aluminum porous bodies A to D, it was confirmed that the moisture adsorption (mg/m²) of the aluminum porous bodies A and B was much lower than the moisture adsorption of the aluminum porous bodies C and D. Table I shows the results. In the aluminum porous bodies A and B, the amount of moisture in an atmosphere the porous bodies adsorb again was also small.

TABLE I

| | Heat treatment conditions | | | | | | | |
|---|---|---|---|---|---|---|---|---|
| | Removal of moisture | | | Removal of base | | | Evaluation | |
| | | | Dew point | | | Dew point | Moisture | |
| | Temperature | Time | temperature | Temperature | Time | temperature | adsorption | |
| | (° C.) | (minute) | (° C.) | (° C.) | (minute) | (° C.) | (mg/m²) | Skeleton surface |
| Example 1 | 150 | 60 | −15 | 600 | 20 | −15 | 15 | Smooth |
| Example 2 | Temperature (° C.): 500° C., Time (minute): 20 minutes, | | | | | | 12 | Smooth |
| | Dew point temperature (° C.): −15° C. | | | | | | | |
| Comparative | — | — | — | 600 | 20 | 20 | 31 | Infinite number of |
| Example 1 | | | | | | | | fine irregularities |
| Comparative | — | — | — | 600 | 20 | 2 | 28 | Infinite number of |
| Example 2 | | | | | | | | fine irregularities |

### <Microscope Observation>

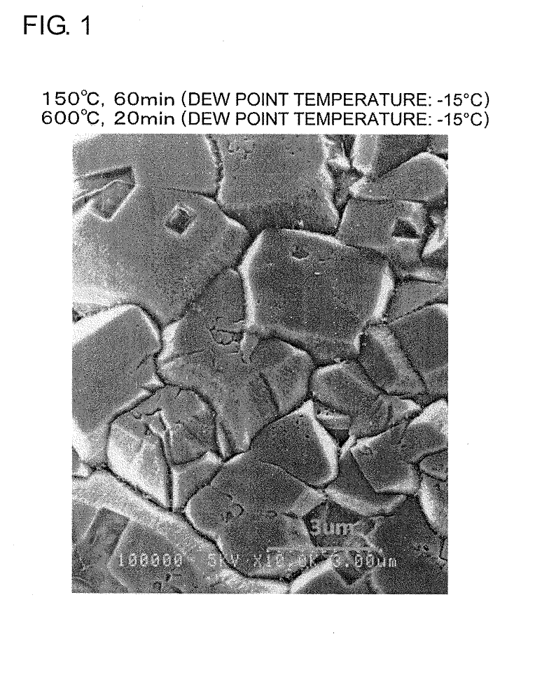

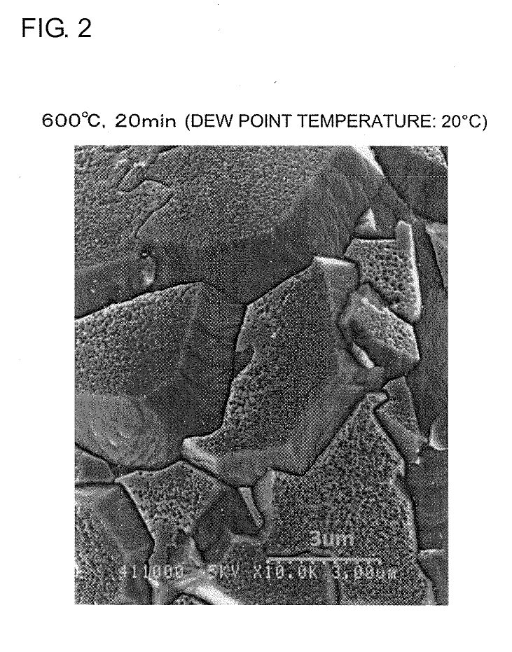

The aluminum porous body A was observed with an electron microscope. It was confirmed that fine irregularities were not formed on the skeleton surface as illustrated in FIG. 1. The aluminum porous body C was observed with an electron microscope in the same manner. It was confirmed that an infinite number of fine irregularities were formed on the skeleton surface as illustrated in FIG. 2.

### <Production of Capacitor>

The aluminum porous bodies A to D were used as current collectors A to D, respectively, and pores of the aluminum porous bodies A to D were filled with an active material to produce electrodes A to D. In the production of the electrodes A to D, a drying treatment was performed at 150° C. at 5 Torr for 2 hours. The above-described lithium ion capacitors A to D were produced using the electrodes A to D and evaluated.

As a result, the generation of gas was not confirmed from the lithium ion capacitors A and B using the aluminum porous bodies A and B whereas the generation of gas caused by a side reaction was confirmed from the lithium ion capacitors C and D using the aluminum porous bodies C and D. This may be because the drying conditions for the aluminum porous bodies C and D were not sufficient and thus moisture and the electrolyte were reacted with each other in the capacitor.

### REFERENCE SIGNS LIST

60 lithium battery
61 positive electrode
62 negative electrode
63 solid electrolyte layer (SE layer)
64 positive electrode layer (positive electrode body)
65 positive electrode current collector
66 negative electrode layer
67 negative electrode current collector
121 positive electrode
122 negative electrode
123 separator
124 presser plate
125 spring
126 pressing member
127 case
128 positive electrode terminal
129 negative electrode terminal
130 lead wire
141 polarizable electrode
142 separator
143 organic electrolyte
144 lead wire
145 case
146 positive electrode
147 negative electrode
148 lead wire
149 lead wire

1. A production method for an aluminum porous body, comprising:
a step of producing a resin structure by forming an aluminum film on a surface of a resin base having a three-dimensional network structure by molten salt electrolytic plating;
a step of removing moisture from the resin structure; and
a step of removing the base by heat-treating the resin structure from which moisture has been removed.

2. The production method for an aluminum porous body according to claim 1,
wherein in the step of removing moisture from the resin structure, the resin structure is heat-treated at a temperature of 50° C. or higher and 300° C. or lower, and
in the step of removing the base, the resin structure is heat-treated at a temperature equal to or higher than 370° C. and lower than the melting point of aluminum.

3. The production method for an aluminum porous body according to claim 1, wherein in the step of removing moisture from the resin structure, the resin structure is heat-treated at a temperature of 370° C. or higher and 500° C. or lower in an atmosphere with a dew point temperature of 0° C. or lower.

4. An aluminum porous body produced by the production method for an aluminum porous body according to claim 1.

5. A current collector for an electrochemical device, comprising the aluminum porous body according to claim 4.

6. An electrode for an electrochemical device, comprising an active material in pores of the aluminum porous body according to claim 4.

7. An electrochemical device comprising the electrode according to claim 6.
